(19) United States
(12) Patent Application Publication
(10) Pub. No.: US 2006/0097029 A1
(43) Pub. Date: May 11, 2006

(54) Method of flip-chip bonding

(75) Inventors: Norio Kainuma, Kawasaki (JP); Hidehiko Kira, Kawasaki (JP); Kenji Kobae, Kawasaki (JP); Takayoshi Matsumura, Kawasaki (JP); Yukio Ozaki, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/062,959

(22) Filed: Feb. 23, 2005

(30) Foreign Application Priority Data
Nov. 9, 2004 (JP) 2004-324639

(51) Int. Cl. B23K 1/06

(52) U.S. Cl. 228/110.1

(57) ABSTRACT

A method of flip-chip bonding can favorably activate the bonding surfaces and remove oxide films when bonding pads and bumps of a semiconductor chip and a substrate and avoids problems such as the bumps being excessively flattened and the bonds between connection terminals being destroyed by subsequent ultrasonic vibration. The method includes an aligning step 2 that aligns and places in contact bumps or pads of a semiconductor chip and pads or bumps of a substrate, a leveling step 4 that levels the shapes of the bumps by pressing together the semiconductor chip and the substrate with a first predetermined load, a bonding preparation step 6 that applies ultrasonic vibration to the semiconductor chip and/or the substrate so that the amplitude of the ultrasonic vibration gradually increases while the first predetermined load weakens, and a bonding step 8 that bonds the bumps and pads by applying ultrasonic vibration to the semiconductor chip and/or the substrate in a state where the semiconductor chip and the substrate are pressed together with a second predetermined load that is smaller than the first predetermined load.

### BACKGROUND OF THE INVENTION

1. Field of the Invention

The present invention relates to a method of flip-chip bonding that bonds bumps and pads of a semiconductor chip and a substrate by placing bumps or pads of the semiconductor chip in contact with pads or bumps of the substrate and applying ultrasonic vibration to the semiconductor chip.

2. Related Art

In recent years, when manufacturing semiconductor devices such as semiconductor packages, flip-chip bonding to mount a semiconductor chip on a circuit board has been carried out using a method that places bumps (bonding terminals) of the semiconductor chip and pads (bonding terminals) of the circuit board in contact and applies ultrasonic vibration to the semiconductor chip to bond the bumps of the semiconductor chip and the pads of the circuit board together.

It should be noted that there are also cases where bumps are provided on the circuit board and pads are provided on the semiconductor chip.

According to this method of bonding, the bumps and pads are strongly rubbed against each other by the ultrasonic vibration, which causes an alloying reaction to take place between the metal forming the bumps and the metal forming the pads and results in the bumps and pads being bonded together.

It should be noted that as the combination of materials for the bumps and pads, it is normal to use a combination of gold (Au) bumps as the bumps and gold (Au) or aluminum (Al) as the pads.

With this kind of bonding method that uses ultrasonic vibration, there are cases where a sufficient connecting strength is not achieved for the bumps and pads due to reasons such as an oxide film being formed on the surfaces of the bumps and/or pads and the stress generated between the bumps and pads becoming uneven due to the ends of stud bumps being too pointed.

Although not a method of flip-chip bonding, a technique has been conventionally proposed that produces favorable connections between the connection terminals by adjusting the load applied between the bonding terminals when wire bonding of a semiconductor device is carried out using ultrasonic vibration.

In Patent Document 1, a technique is disclosed where large loads (first and second bonding loads) are first applied between the terminals to remove oxide films and the like, with the load then being switched to a light load (a third bonding load) and ultrasonic vibration being applied to connect the terminals (see Paragraphs 0010 and 0011 and FIG. 2 of Patent Document 1).

Also in Patent Document 1, a technique is disclosed that applies, as a final stage of bonding, an intermediate load (a fourth bonding load) that is lighter than the first bonding load but larger than the third bonding load while ultrasonic vibration is still being applied to strengthen the connections (see Paragraph 0014 and FIG. 2 of Patent Document 1).

In Patent Document 2, a technique is disclosed where ultrasonic vibration starts being applied in a state where a large load is applied between the terminals and then the load is reduced and bonding is carried out (see Paragraph 0007 and FIGS. 1 and 2 of Patent Document 2).

Patent Document 1

Japanese Laid-Open Patent Publication No. H10-125711 (Paragraphs 0010 to 0011, 0014 and FIG. 2)

Patent Document 2

Japanese Laid-Open Patent Publication No. H04-279040 (Paragraph 0007 and FIGS. 1 and 2)

However, during the method of wire bonding disclosed in Patent Document 1, a large load is merely applied between the terminals before the ultrasonic vibration is applied, so that there is the problem of the activation of the bonding surfaces of the terminals and the removal of the oxide films being insufficiently achieved.

On the other hand, in the method of wire bonding disclosed in Patent Document 2, ultrasonic vibration is applied in a state where a large load is applied between the terminals, so that the bonding terminals that are constructed of fine metal wires or the like are excessively flattened and so extend outwards horizontally. Accordingly, this method is not suited to flip-chip bonding where the gaps between terminals are minute.

Also, in the bonding steps that bond the bonding terminals in Patent Documents 1 and 2 (the bonding step that applies the third and fourth bonding loads in Patent Document 1 and the bonding step that applies the low loads A and B in Patent Document 2), ultrasonic vibration is applied with the load applied to the bonding terminals being kept constant or being increased, so that the bonding terminals are excessively flattened.

In addition, many bonding terminals need to be bonded together during flip-chip bonding, so that all of the bonding terminals are not bonded simultaneously and the timing at which respective bonding terminals are bonded differs. In particular, when ultrasonic vibration is applied during flip-chip bonding with the load on the bonding terminals being kept constant or increasing, there is the problem of the bonds between the bonding terminals that are bonded together first being destroyed by subsequent ultrasonic vibration, which weakens the bonding strength.

### SUMMARY OF THE INVENTION

The present invention was conceived to solve the problems described above and it is an object of the present invention to provide a method of flip-chip bonding that can favorably activate the bonding surfaces and remove oxide films when bonding pads and bumps of a semiconductor chip and a substrate and avoids problems such as the excessive flattening of the bumps and destruction of the bonds between connection terminals by subsequent ultrasonic vibration.

To solve the problems described above, a method of flip-chip bonding according to the present invention includes: a leveling step that levels shapes of bumps of a semiconductor chip by pressing together a semiconductor chip and a substrate with a first predetermined load; an ultrasonic vibration applying step that applies ultrasonic vibration to the semiconductor chip and/or the substrate so that the amplitude of the ultrasonic vibration gradually increases while the first predetermined load gradually weakens; and a bonding step that bonds pads of the substrate and the bumps by applying ultrasonic vibration to the semiconductor chip and/or the substrate in a state where the semiconductor chip and the substrate are pressed together with a second predetermined load that is smaller than the first predetermined load.

By doing so, during the ultrasonic vibration applying step that applies ultrasonic vibration so that the amplitude gradually increases while the first predetermined load gradually weakens, the activation of the bonding surfaces and the removal of the oxide films can be favorably achieved without greatly flattening the shapes of the bumps.

In addition, during the ultrasonic vibration applying step, the load applied to the semiconductor chip and the substrate may gradually weaken from the first predetermined load to the second predetermined load, and the ultrasonic vibration applying step and the bonding step may be carried out continuously.

By doing so, the leveling step, the ultrasonic vibration applying step, and the bonding step can be carried out continuously while continuously changing the load, so that bonding can be carried out in a short time.

In addition, during the bonding step, the amplitude of the ultrasonic vibration may be gradually reduced.

Also, during the bonding step, the load applied between the semiconductor chip and the substrate may be gradually reduced from the second predetermined load.

The semiconductor chip may be held on a bonding tool by suction, and in the bonding step, a suction force that holds the semiconductor chip may be gradually reduced.

By doing so, the force applied between the pads and the bumps gradually weakens, so that the bonded state of the bonded pads and bumps is not destroyed by subsequent ultrasonic vibration.

The method may further include, after the bonding step, a bond strengthening step that applies ultrasonic vibration with an amplitude no greater than the amplitude during the bonding step to the semiconductor chip and/or the substrate and presses together the semiconductor chip and the substrate with a third predetermined load that is larger than the second predetermined load.

By doing so, during the bond strengthening step, the amplitude of the ultrasonic vibration is reduced and the load is increased, so that the bonded state of the bonded pads and bumps is not destroyed. Also, cavities present in the bonding surfaces are eradicated and the bonding surface area is increased, so that the bonding strength can be increased.

Another method of flip-chip bonding according to the present invention includes a bonding step that bonds bumps of a semiconductor chip and pads of a substrate by applying ultrasonic vibration to the semiconductor chip and/or the substrate in a state where the semiconductor chip and the substrate are pressed together with a predetermined load, wherein an amplitude of the ultrasonic vibration is gradually reduced during the bonding step.

By doing so, the force applied between the pads and bumps gradually weakens, so that the bonded state of bonded pads and bumps is not destroyed by subsequent ultrasonic vibration.

Yet another method of flip-chip bonding according to the present invention includes a bonding step that bonds bumps of a semiconductor chip and pads of a substrate by applying ultrasonic vibration to the semiconductor chip and/or the substrate in a state where the semiconductor chip and the substrate are pressed together with a predetermined load, wherein a load applied between the semiconductor chip and the substrate is gradually reduced during the bonding step.

By doing so, the force applied between the pads and bumps gradually weakens, so that the bonded state of bonded pads and bumps is not destroyed by subsequent ultrasonic vibration.

Yet another method of flip-chip bonding according to the present invention includes: an attachment step that attaches a semiconductor chip to a bonding tool using suction; and a bonding step that bonds bumps of the semiconductor chip and pads of a substrate by applying ultrasonic vibration to the semiconductor chip and/or the substrate in a state where the semiconductor chip and the substrate are pressed together with a predetermined load, wherein in the bonding step, a suction force that holds the semiconductor chip is gradually reduced.

By doing so, the force applied between the pads and bumps gradually weakens, so that the bonded state of bonded pads and bumps is not destroyed by subsequent ultrasonic vibration.

According to the method of flip-chip bonding according to the present invention, when the pads and bumps of a semiconductor chip and a substrate are bonded, the activation of the bonding surfaces and removal of the oxide films are favorably achieved and an excessive flattening of the bumps and destruction of the bonds between connection terminals by subsequent ultrasonic vibration are avoided.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a diagram showing the construction of an embodiment of a bonding apparatus that flip-chip bonds a semiconductor chip to a circuit board using a method of flip-chip bonding according to the present invention; and

FIG. 2 is a graph showing the operation of a bonding tool (an ultrasonic head), the ultrasonic output of the ultrasonic head to the semiconductor chip, a load profile between the semiconductor chip and the circuit board, and an amplitude profile for ultrasound applied to the semiconductor chip for the method of flip-chip bonding according to the present invention.

### DESCRIPTION OF THE PREFERRED EMBODIMENTS

Preferred embodiments of a method of flip-chip bonding according to the present invention will now be described in detail with reference to the attached drawings.

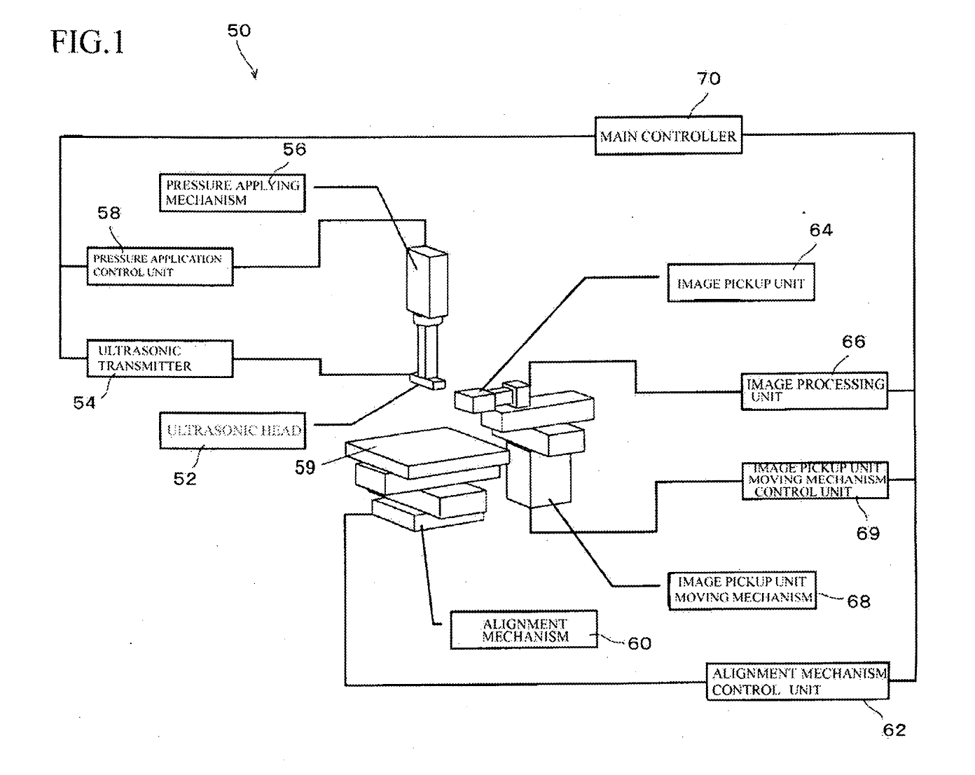

FIG. 1 is a diagram showing the construction of an embodiment of a bonding apparatus that flip-chip bonds a semiconductor chip to a circuit board using a method of flip-chip bonding according to the present invention.

A flip-chip bonding apparatus 50 includes, as a construction on an ultrasonic head side, an ultrasonic head 52 that serves as a bonding tool and to which a semiconductor chip is attached by suction of air so that the semiconductor chip is supported on the ultrasonic head 52, an ultrasonic transmitter 54 that applies ultrasonic vibration to the ultrasonic head 52, a pressure applying mechanism 56 that applies pressure onto the semiconductor chip toward the circuit board, and a pressure application control unit 58 that controls the load applied by the pressure applying mechanism 56.

The flip-chip bonding apparatus 50 also includes, as a construction on the same side as a support table 59 that supports the circuit board, an alignment mechanism 60 that supports the support table 59 so as to be movable in X-Y-θ directions in accordance with the alignment position, and an alignment mechanism control unit 62 that controls the position of the alignment mechanism 60 to adjust the relative positions of the semiconductor chip and the circuit board during flip-chip bonding.

The flip-chip bonding apparatus 50 also includes, as a detection mechanism that detects the relative disposed positions of the semiconductor chip and the circuit board, an image pickup unit 64, an image processing unit 66 that carries out image processing on images obtained from the image pickup unit 64, an image pickup unit moving mechanism 68 that supports the image pickup unit 64 so as to be movable to a freely chosen position, and an image pickup unit moving mechanism control unit 69 that drives the image pickup unit moving mechanism 68 to move the image pickup unit 64 to a predetermined position.

A main controller 70 controls the alignment mechanism control unit 62 based on a detection result of the image processing unit 66 to mutually align the semiconductor chip and the circuit board. While controlling, via the pressure application control unit 58, the load during flip-chip bonding using a load sensor (not shown), the main controller 70 also drives the ultrasonic transmitter 54 to control an operation that bonds the semiconductor chip to the predetermined position on the circuit board.

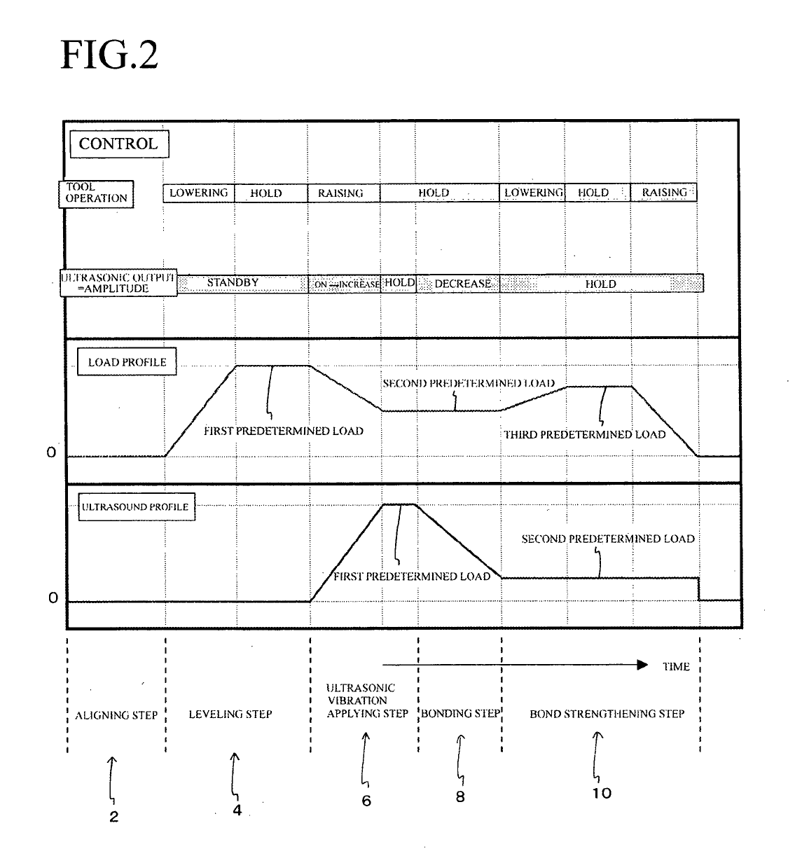

Next, the method of flip-chip bonding according to the present embodiment will be described with reference to FIG. 2.

FIG. 2 is a graph showing the operation of the bonding tool (the ultrasonic head 52) due to the main controller 70 controlling the pressure applying mechanism 56, the ultrasonic output of the ultrasonic head 52 to the semiconductor chip, a load profile between the semiconductor chip and the circuit board, and an amplitude profile for the ultrasound applied to the semiconductor chip.

First, the main controller 70 has a semiconductor chip attached to and held on the ultrasonic head 52 by suction (an attachment step).

The main controller 70 next controls the alignment mechanism control unit 62 based on a detection result of the image processing unit 66 to mutually align bumps of the semiconductor chip attached to the ultrasonic head 52 and the pads of the circuit board mounted on the support table 59 and has the ultrasonic head 52 and the semiconductor chip lowered by the pressure application control unit 58 so that the bumps of the semiconductor chip and the pads of the circuit board are placed in contact (an aligning step 2).

After lowering the ultrasonic head 52 to place the bumps and pads in contact in the aligning step 2, the main controller 70 has the ultrasonic head 52 lowered to a position where the load between the semiconductor chip and the circuit board becomes a first predetermined load that is set in advance and, by stopping the lowering of the ultrasonic head 52 and maintaining the position for a predetermined time, has the shapes of the bumps leveled (a leveling step 4).

It should be noted that after the pads and bumps are placed in contact, control is carried out so that the load reaches the first predetermined load in a predetermined period and the first predetermined load is maintained for a predetermined period. The control that maintains the first predetermined load for a predetermined period is constructed so that a timer inside the main controller 70 is started as a trigger for the load sensor to detect the first predetermined load and when the count value of the timer has reached a value that corresponds to the predetermined time, the process next moves to an ultrasonic vibration applying step 6. Control over the respective periods described later can be realized by the same process, and therefore description thereof is omitted hereinafter.

During the processing thus far, ultrasonic vibration is not applied to the semiconductor chip.

Next, in the ultrasonic vibration applying step 6, the main controller 70 controls the pressure application control unit 58 so that the first predetermined load gradually weakens, and while doing so, ultrasonic vibration is applied to the semiconductor chip so that the amplitude of the ultrasonic vibration gradually increases.

During the ultrasonic vibration applying step 6, the main controller 70 carries out control so that the load between the semiconductor chip and the circuit board is reduced to a second predetermined load that is set in advance and is smaller than the first predetermined load described above. At the same time, the main controller 70 carries out control so that the amplitude of the ultrasonic vibration increases to a first predetermined amplitude that is set in advance.

The amplitude is controlled by adjusting the driving voltage applied to the ultrasonic transmitter 54.

The timing at which the reduction of the load commences and the timing at which the application of the ultrasonic vibration commences are controlled so as to match. It is also favorable to carry out control to make the timing at which the load reaches the second predetermined load and the timing at which the amplitude of the ultrasonic vibration reaches the first predetermined amplitude as close as possible.

It should be noted that as shown in FIG. 2, during the ultrasonic vibration applying step 6, the second predetermined load and the first predetermined load should also be maintained for a predetermined period.

Next, during a bonding step 8, the main controller 70 gradually reduces the amplitude of the ultrasonic vibration from the first predetermined amplitude while the load between the semiconductor chip and the circuit board is maintained at the second predetermined load. As shown in FIG. 2, the amplitude is controlled so as to decrease to a second predetermined amplitude that is smaller than the first predetermined amplitude.

In a following bond strengthening step 10, while the amplitude of the ultrasonic vibration applied to the semiconductor chip is maintained at the second predetermined amplitude, pressing together is carried out with the load between the semiconductor chip and the circuit board at a third predetermined load that is set in advance and is larger than the second predetermined load but smaller than the first predetermined load.

According to the method of flip-chip bonding according to the present embodiment, during the ultrasonic vibration applying step the ultrasonic vibration is applied so that the amplitude gradually increases while the first predetermined load is gradually reduced. As a result, it is possible to favorably activate the bonding surfaces and remove oxide films without significantly flattening the shapes of the bumps.

That is, the problem of the activation of the bonding surfaces and removal of the oxide films being insufficiently achieved when a large load is simply applied before bonding as in the technique disclosed in Patent Document 1 is solved. At the same time, since ultrasonic vibration is applied while the load is gradually reduced, the problem of the shapes of the bonding terminals being significantly flattened due to the ultrasonic bonding commencing in a state where a large load is being applied as in the technique disclosed in Patent Document 2 is solved.

In addition, since the amplitude of the ultrasonic vibration gradually decreases in the bonding step 8, the force that acts between the pads and the bumps gradually weakens and the bonded state of the bonded pads and bumps is not destroyed due to subsequent ultrasonic vibration.

That is, as described above, during flip-chip bonding, the respective connection terminals are bonded together as soon as the connection terminals rub against each other, but by gradually reducing the force that acts between the pads and the bumps, it is possible to avoid the problem of the bonding strength falling due to the bonds between the bonding terminals that are bonded together first being destroyed by subsequent ultrasonic vibration, and the bonding of connection terminals that are in a mid-bonding state can be allowed to continue.

It should be noted that for the present invention, the construction for not destroying the bonds between connection terminals (i.e., pads and bumps) that have been initially bonded during the bonding step is not limited to a construction that gradually reduces the amplitude of the ultrasonic vibration. For example, the same effect can be obtained by gradually reducing the force that acts between the connection terminals by gradually reducing the load applied between the semiconductor chip and the substrate during the bonding step from the second predetermined load described above. The same effect can also be obtained by reducing the energy of the ultrasonic vibration transmitted from the ultrasonic head 52 to the semiconductor chip by gradually reducing the suction force that holds the semiconductor chip during the bonding step.

In addition, since the load is increased and the amplitude of the ultrasonic vibration is reduced during the bond strengthening step 10, the bonded state of the bonded pads and bumps is not destroyed. The bonding strength can also be increased by eradicating cavities present in the bonding surfaces and thereby increasing the bonding surface area.

Although an example where pads are provided on the substrate and bumps are provided on the semiconductor chip has been described in the present embodiment, the present invention can also be applied to the bonding of a semiconductor chip where bumps are provided on the substrate and pads are provided on the semiconductor chip.

Also, the ultrasonic vibration is not limited to being applied to only the semiconductor chip, and it is also possible to use a construction where the ultrasonic vibration is applied to only the substrate or to both the substrate and the semiconductor chip.

What is claimed is:

1. A method of flip-chip bonding comprising:
a leveling step that levels shapes of bumps of a semiconductor chip by pressing together a semiconductor chip and a substrate with a first predetermined load;
an ultrasonic vibration applying step that applies ultrasonic vibration to the semiconductor chip and/or the substrate so that the amplitude of the ultrasonic vibration gradually increases while the first predetermined load gradually weakens; and
a bonding step that bonds pads of the substrate and the bumps by applying ultrasonic vibration to the semiconductor chip and/or the substrate in a state where the semiconductor chip and the substrate are pressed together with a second predetermined load that is smaller than the first predetermined load.

2. A method of flip-chip bonding according to claim 1,
wherein during the ultrasonic vibration applying step, the load applied to the semiconductor chip and the substrate gradually weakens from the first predetermined load to the second predetermined load, and
the ultrasonic vibration applying step and the bonding step are carried out continuously.

3. A method of flip-chip bonding according to claim 1,
wherein during the bonding step, the amplitude of the ultrasonic vibration is gradually reduced.

4. A method of flip-chip bonding according to claim 1,
wherein during the bonding step, the load applied between the semiconductor chip and the substrate is gradually reduced from the second predetermined load.

5. A method of flip-chip bonding according to claim 1,
wherein the semiconductor chip is held on a bonding tool by suction, and
during the bonding step, a suction force that holds the semiconductor chip is gradually reduced.

6. A method of flip-chip bonding according to claim 1, further comprising, after the bonding step, a bond strengthening step that applies ultrasonic vibration with an amplitude no greater than the amplitude during the bonding step to the semiconductor chip and/or the substrate and presses together the semiconductor chip and the substrate with a third predetermined load that is larger than the second predetermined load.

7. A method of flip-chip bonding comprising
a bonding step that bonds bumps of a semiconductor chip and pads of a substrate by applying ultrasonic vibration to the semiconductor chip and/or the substrate in a state where the semiconductor chip and the substrate are pressed together with a predetermined load,
wherein an amplitude of the ultrasonic vibration is gradually reduced during the bonding step.

8. A method of flip-chip bonding comprising
a bonding step that bonds bumps of a semiconductor chip and pads of a substrate by applying ultrasonic vibration to the semiconductor chip and/or the substrate in a state where the semiconductor chip and the substrate are pressed together with a predetermined load,
wherein a load applied between the semiconductor chip and the substrate is gradually reduced during the bonding step.

9. A method of flip-chip bonding comprising:
an attachment step that attaches a semiconductor chip to a bonding tool using suction; and
a bonding step that bonds bumps of the semiconductor chip and pads of a substrate by applying ultrasonic vibration to the semiconductor chip and/or the substrate in a state where the semiconductor chip and the substrate are pressed together with a predetermined load,
wherein during the bonding step, a suction force that holds the semiconductor chip is gradually reduced.
